(19) United States
(12) Patent Application Publication
(10) Pub. No.: US 2013/0300247 A1
(43) Pub. Date: Nov. 14, 2013

(54) STATOR OF ROTATING ELECTRIC MACHINE AND WINDING METHOD THEREFOR

(71) Applicants: Fumiaki Tsuchiya, Chiyoda-ku (JP); Akira Watarai, Chiyoda-ku (JP); Daisuke Shijyo, Chiyoda-ku (JP)

(72) Inventors: Fumiaki Tsuchiya, Chiyoda-ku (JP); Akira Watarai, Chiyoda-ku (JP); Daisuke Shijyo, Chiyoda-ku (JP)

(73) Assignee: MITSUBISHI ELECTRIC CORPORATION, Chiyoda-ku, Tokyo (JP)

(21) Appl. No.: 13/981,016

(22) PCT Filed: Feb. 14, 2011
(86) PCT No.: PCT/JP2011/053057

§ 371 Date: Jul. 22, 2013

(51) Int. Cl. H02K 3/12; H02K 15/095

(52) U.S. Cl. CPC H02K 3/12; H02K 15/095
USPC 310/208; 242/432

(57) ABSTRACT

A stator of a rotating electric machine includes: a plurality of teeth having a same shape are arranged in a radial direction toward a rotary shaft core with base ends thereof being coupled to a core back in a ring shape; a slot formed between the adjacent teeth; a flange portion formed projecting to opposite sides of apical ends of the teeth; a slot inlet formed between the adjacent flange portions; a winding area formed around each teeth; and a wire wound via an insulator having a same shape in each winding area. A first wire is wound around first teeth provided alternately, and a second wire is wound around second teeth put between the first teeth, and the first wire and the second wire are wound in a different shape in a sectional shape of opposing portions.

### FIELD

The present invention relates to a stator of a rotating electric machine such as a motor or an electric generator and a winding method therefor.

### BACKGROUND

Conventionally, in a stator of a rotating electric machine such as a motor or an electric generator, there have been proposed several devices having a different winding arrangement in adjacent teeth for improving a space factor (a winding density) and for downsizing the device. For example, in Patent Literatures 1 and 3, a concavity, a convexity and a taper are provided in an insulator arranged between teeth and a wire, so that adjacent insulators have a different shape, thereby providing a different winding arrangement in the adjacent teeth. Furthermore, in Patent Literature 2, by using a winding machine having unique specifications, a different winding arrangement is provided in adjacent teeth.

### CITATION LIST

### Patent Literatures

Patent Literature 1: Japanese Patent Application Laid-open No. 2006-296146
Patent Literature 2: Japanese Patent No. 4456886
Patent Literature 3: Japanese Patent Application Laid-open No. 2004-104870

### SUMMARY

### Technical Problem

However, according to the method described in Patent Literature 1 mentioned above, because the insulator has a unique shape, its component cost is high, thereby problematically increasing its product cost.

Furthermore, according to the method described in Patent Literature 2, a special winding machine is required, and thus a general winding machine cannot be used. Therefore, there are problems that the component cost and the product cost increase, and the type of machines that can be manufactured is limited.

Further, according to the method described in Patent Literature 3, similarly to the method described in Patent Literature 1, the component cost of the insulator increases, and because the insulator has a tapered shape, the external size of the device problematically increases.

The present invention has been achieved to solve the above problems, and an object of the present invention is to provide a stator of a rotating electric machine, which can have a different winding arrangement in adjacent teeth without using any uniquely-shaped insulator or without using any unique winding machine, and can realize improvement of a space factor (a winding density) and downsizing of the device, and to provide a winding method therefor.

### Solution to Problem

To solve the above problems and achieve the object, according to an aspect of the present invention a stator of a rotating electric machine in which a plurality of teeth having a same shape are arranged in a radial direction toward a rotary shaft core with base ends thereof being coupled to a core back in a ring shape, a slot is formed between the adjacent teeth, a flange portion is formed projecting to opposite sides of apical ends of the teeth, a slot inlet is formed between the adjacent flange portions, a winding area is formed around each teeth, and a wire is wound via an insulator having a same shape in each winding area. And a first wire is wound around first teeth provided alternately, and a second wire is wound around second teeth put between the first teeth, and the first wire and the second wire are wound in a different shape in a sectional shape of opposing portions, so that a convex portion of the first wire corresponds to a concave portion of the second wire, and a concave portion of the first wire corresponds to a convex portion of the second wire.

According to another aspect of the present invention a stator of a rotating electric machine in which a plurality of teeth having a same shape are arranged in a radial direction toward a rotary shaft core with base ends thereof being coupled to a core back in a ring shape, a slot is formed between the adjacent teeth, a flange portion is formed projecting to opposite sides of apical ends of the teeth, a slot inlet is formed between the adjacent flange portions, a winding area is formed around each teeth, and a wire is wound via an insulator having a same shape in each winding area. A first wire is wound around first teeth provided alternately, and a second wire is wound around second teeth put between the first teeth, a surface that radially divides a space in the slot into two in a tapered shape in cross section is designated as a boundary surface, a closest distance between the first wire and the second wire is designated as a minimum insulating distance, the wire is wound in the winding area by one set each while transitioning between the respective teeth, the one set being such that the wire is wound in an m layer in a direction from the base portion having a wide width toward the flange portion having a narrow width of the teeth in the tapered shape in cross section, turned around at a predetermined position, and wound back in an m+1 layer, stacked on the m layer. When the boundary surface is exceeded or the distance from the second wire has reached the minimum insulating distance in an n layer of the first wire, the position is designated as a turn-around position to wind back the wire in an n+1 layer, transition to the second teeth is performed, and when the boundary surface is exceeded or the distance from the first wire has reached the minimum insulating distance in an n layer of the second wire, the position is designated as a turn-around position to wind back the wire, which is designated as one set, and this process is repeated by one set or more, and transition to the first teeth is performed, and the wire is wound while adjusting number of windings so that number of windings of the first wire matches with number of windings of the second wire in the last layer.

According to still another aspect of the present invention, a winding method for a stator of a rotating electric machine in which a plurality of teeth having a same shape are arranged in a radial direction toward a rotary shaft core with base ends thereof being coupled to a core back in a ring shape, a slot is formed between the adjacent teeth, a flange portion is formed projecting to opposite sides of apical ends of the teeth, a slot inlet is formed between the adjacent flange portions, a winding area is formed around each teeth, and a wire is wound via an insulator having a same shape in each winding area. The winding method includes: a step of winding a first wire around first teeth provided alternately, and winding a second wire around second teeth put between the first teeth; a step of designating a surface that radially divides a space in the slot into two in a tapered shape in cross section as a boundary surface; a step of designating a closest distance between the first wire and the second wire as a minimum insulating distance; a step of winding the wire in the winding area by one set each while transitioning between the respective teeth, the one set being such that the wire is wound in an m layer in a direction from the base portion having a wide width toward the flange portion having a narrow width of the teeth in the tapered shape in cross section, turned around at a predetermined position, and wound back in an m+1 layer, stacked on the m layer; a step of winding the wire in an n+1 layer to the base portion, when the boundary surface is exceeded or the distance from the second wire has reached the minimum insulating distance in an n layer of the first wire, by designating the position as a turn-around position; a step of transitioning to the second teeth, and when the boundary surface is exceeded or the distance from the first wire has reached the minimum insulating distance in an n layer of the second wire, winding back the wire by designating the position as a turn-around position, this process being repeated by one set or more; and a step of transitioning to the first teeth, and the wire is wound while adjusting number of windings so that number of windings of the first wire matches with number of windings of the second wire in the last layer.

### Advantageous Effects of Invention

According to the present invention, a first wire is wound around first teeth provided alternately, and a second wire is wound around second teeth put between the first teeth, and the first wire and the second wire are wound in a different shape in a sectional shape of the opposing portions, so that a convex portion of the first wire corresponds to a concave portion of the second wire, and the concave portion of the first wire corresponds to the convex portion of the second wire. Accordingly, improvement of a space factor (a winding density) and downsizing of the device can be realized.

According to the present invention, the first wire is wound around the first teeth provided alternately, and the second wire is wound around the second teeth put between the first teeth. A surface that radially divides a space in a slot into two in a tapered shape in cross section is designated as a boundary surface, and the closest distance between the first wire and the second wire is designated as the minimum insulating distance. The wire is wound in an m layer from a side of a base portion having a wide width toward a flange portion having a narrow width of the teeth in the tapered shape in cross section, turned around at a predetermined position, and wound back in an m+1 layer, stacked on the m layer. This process is designated as one set, and the wire is wound in a winding area by one set each, while transitioning between respective teeth. When the boundary surface is exceeded or the minimum insulating distance is reached, the position is designated as a turn-around position to wind back the wire. With this simple procedure, the first wire and the second wire can be wound in a different shape in the sectional shape of the opposing portions, so that the convex portion of the first wire corresponds to the concave portion of the second wire, and the concave portion of the first wire corresponds to the convex portion of the second wire. Accordingly, a different winding arrangement can be achieved in the adjacent teeth, without using any uniquely-shaped insulator or without using any unique winding machine, thereby realizing improvement of the space factor (the winding density) and downsizing of the device.

### BRIEF DESCRIPTION OF DRAWINGS

FIG. 1 is a sectional view of a part (four teeth) of a stator of a rotating electric machine.

FIG. 2 is an enlarged sectional view of a part C in FIG. 1, and depicts a state of a winding arrangement wound around for one slot.

FIG. 3 is a side view depicting a cross section of a wire winding portion in a wire crossing portion in the winding arrangement for one slot in FIG. 2.

FIG. 4 are side views of one tooth, and depict a first layer wound around teeth and a winding arrangement in the first layer.

FIG. 5 are process diagrams of processes in which wires are stacked from the first layer to the last layer step by step.

FIG. 6 is a sectional view of a winding arrangement of wires wound around in the respective processes shown in FIG. 5, while the wires are shown by changing their colors.

FIG. 7 is a diagram shown for a comparison while corresponding to FIG. 2, and depicts a state of a conventional winding arrangement in which a wire is wound for one slot.

FIG. 8 is a diagram shown for a comparison while corresponding to FIG. 3, and is a side view depicting a cross section of a wire winding portion in a wire crossing portion in the conventional winding arrangement for one slot.

### DESCRIPTION OF EMBODIMENTS

Exemplary embodiments of a stator of a rotating electric machine according to the present invention will be explained below in detail with reference to the accompanying drawings. The present invention is not limited to the embodiments.

### Embodiment

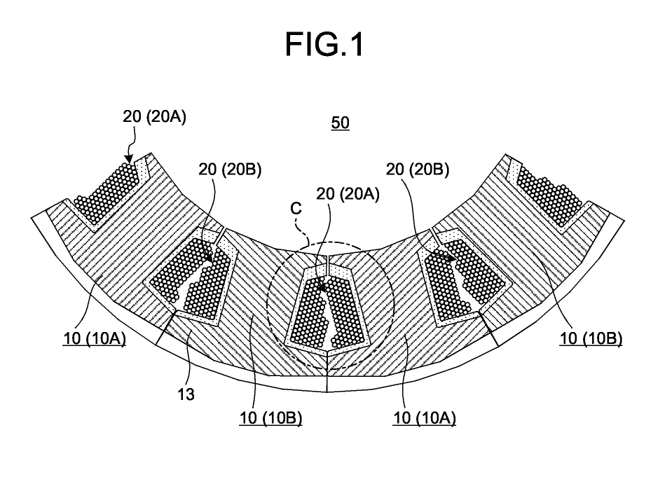

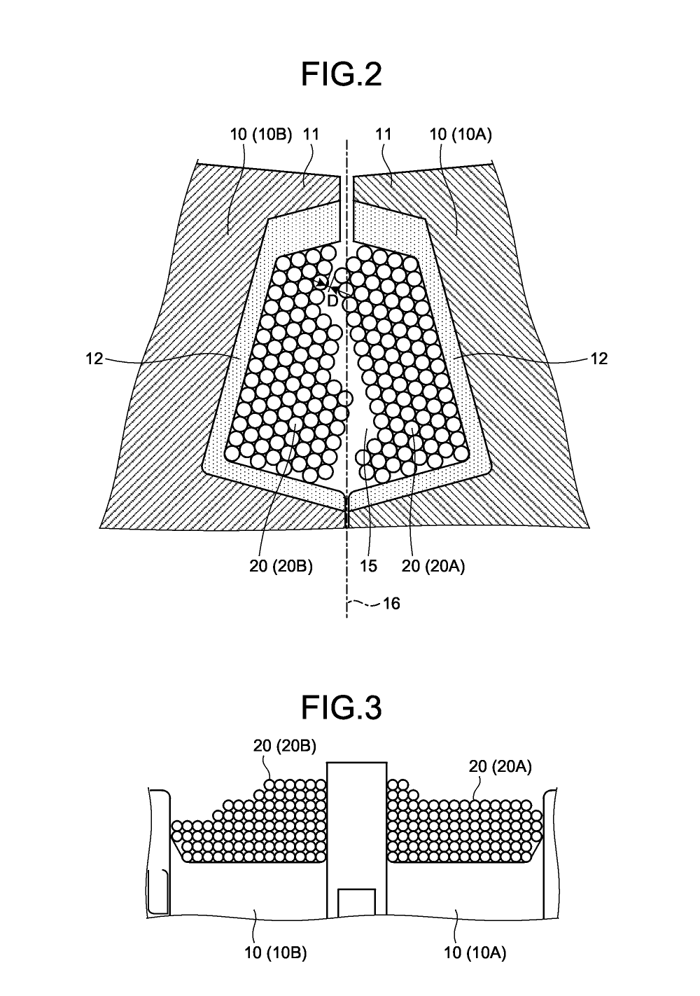

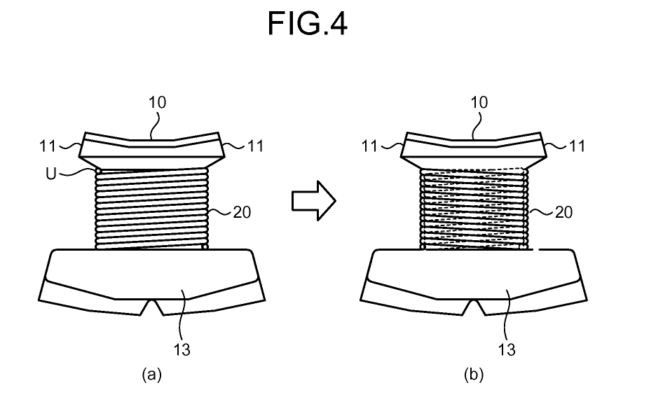

FIG. 1 is a sectional view of a part (four teeth) of a stator of a rotating electric machine. FIG. 2 is an enlarged sectional view of a part C in FIG. 1, and depicts a state of a winding arrangement wound around for one slot. FIG. 3 is a side view depicting a cross section of a wire winding portion in a wire crossing portion in the winding arrangement for one slot in FIG. 2. FIG. 4 are side views of one tooth, and depict a first layer wound around teeth and a winding arrangement in the first layer. While FIG. 1 depicts a stator for four teeth, the stator has 12 teeth in total.

A stator 50 includes a plurality of teeth 10 in a radial direction toward a rotary shaft core. Base ends of the teeth 10 are coupled to a core back 13 in a ring shape. A slot 15 is formed between the adjacent teeth 10. A flange portion 11 is formed projecting to opposite sides of apical ends of the teeth 10. A slot inlet is formed between the adjacent flange portions 11, 11. The space in the slot 15 is virtually split into two in a tapered shape by a boundary surface 16 extending in the radial direction. The winding area in which a wire 20 is wound is formed around the respective teeth 10 while including a space within the slot 15 split into two by the boundary surface 16. The wire 20 is wound in the winding area of the respective teeth 10 via an insulator 12.

The first wire 20 (20A) is wound around the first teeth 10 (10A) provided alternately, and the second wire 20 (20B) is wound around the second teeth 10 (10B) put between the first teeth 10A. The closest distance between a first wire 20A and the second wire 20B is designated as a minimum insulating distance D. That is, the first wire 20A and the second wire 20B are away by the minimum insulation distance D even at the closest position.

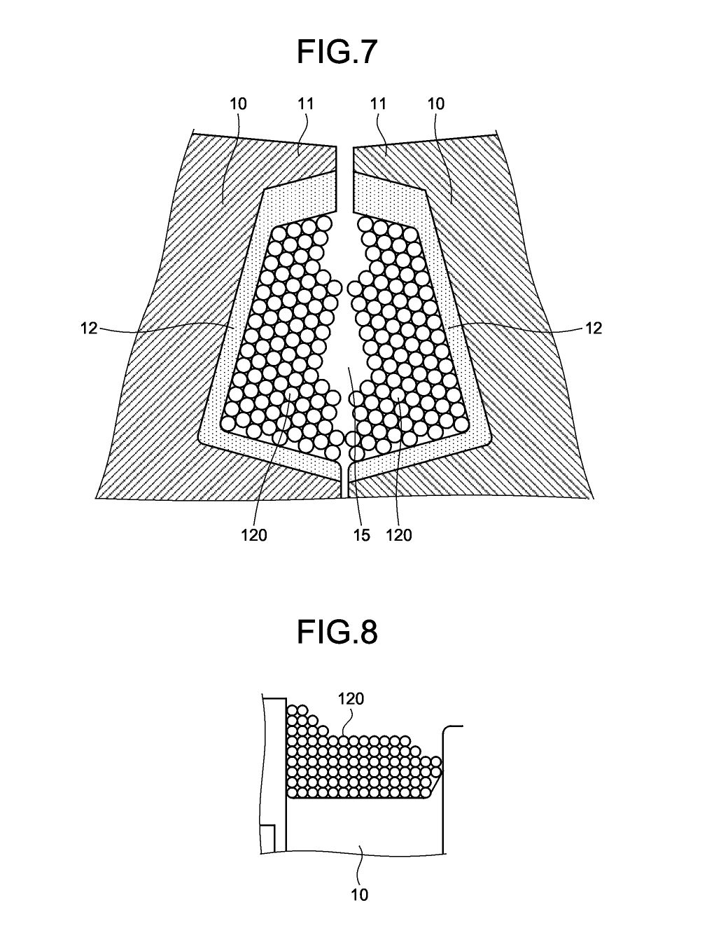

FIG. 7 is a diagram shown for a comparison while corresponding to FIG. 2, and depicts a state of a conventional winding arrangement in which a wire is wound for one slot. FIG. 8 is a diagram shown for a comparison while corresponding to FIG. 3, and is a side view depicting a cross section of a wire winding portion in a wire crossing portion in the conventional winding arrangement for one slot. Conventionally, a wire 120 has been wound around adjacent teeth 10 in the same winding arrangement. Therefore, convex portions of the wire 120 in the adjacent teeth have been at positions facing each other, and concave portions have been at positions facing each other, thereby forming a useless space between the concave portions.

According to the stator 50 of the present embodiment, in the sectional shape of the opposing portions, the wires 20A and 20B are wound in a different shape so that the convex portion of the first wire 20A corresponds to the concave portion of the second wire 20B, and the concave portion of the first wire 20A corresponds to the convex portion of the second wire 20B. The concave portions and the convex portions thereof are arranged to engage with each other, with a predetermined gap being maintained. That is, by applying the winding arrangement method according to the present embodiment, the adjacent wires 20, 20 have different winding arrangements to engage with each other, as shown in FIG. 2, while maintaining a predetermined gap. Accordingly, the winding space factor and efficiency of the motor can be improved, and a required insulating distance can be ensured, as compared to the conventional winding arrangement (FIG. 7). Furthermore, as shown in FIG. 3, the number of winding layers can be decreased in an axial direction of the motor and the axial size of the motor can be reduced than in the conventional winding arrangement (FIG. 8).

In making the winding arrangements different between the adjacent teeth, conventionally, a winding target (an insulator or the like) has been required to be formed in a unique shape or a unique winding machine has been required. Therefore, manufacturing of a wide variety of products has been difficult and required a high cost. In the present embodiment, because a general purpose product can be used, manufacturing of a wide variety of products becomes easy and a cost reduction can be realized.

By applying the winding arrangement method according to the present embodiment, because a winding end position is always on a side of the core back 13, wire connection and a transition process between the adjacent teeth 10, 10 can be facilitated, and a reduction of a winding time (a cost reduction) can be realized by a continuous winding process.

Furthermore, the winding alignment is improved by applying the winding arrangement method according to the present embodiment. FIG. 4(a) depicts a winding arrangement in the first layer wound around the teeth, and FIG. 4(b) depicts a winding arrangement in the first and second layers wound around the teeth. As shown in FIG. 4, the wire crosses on a short side of the teeth 10, and the wire to be wound and stacked always comes in contact with each other to improve the wire alignment.

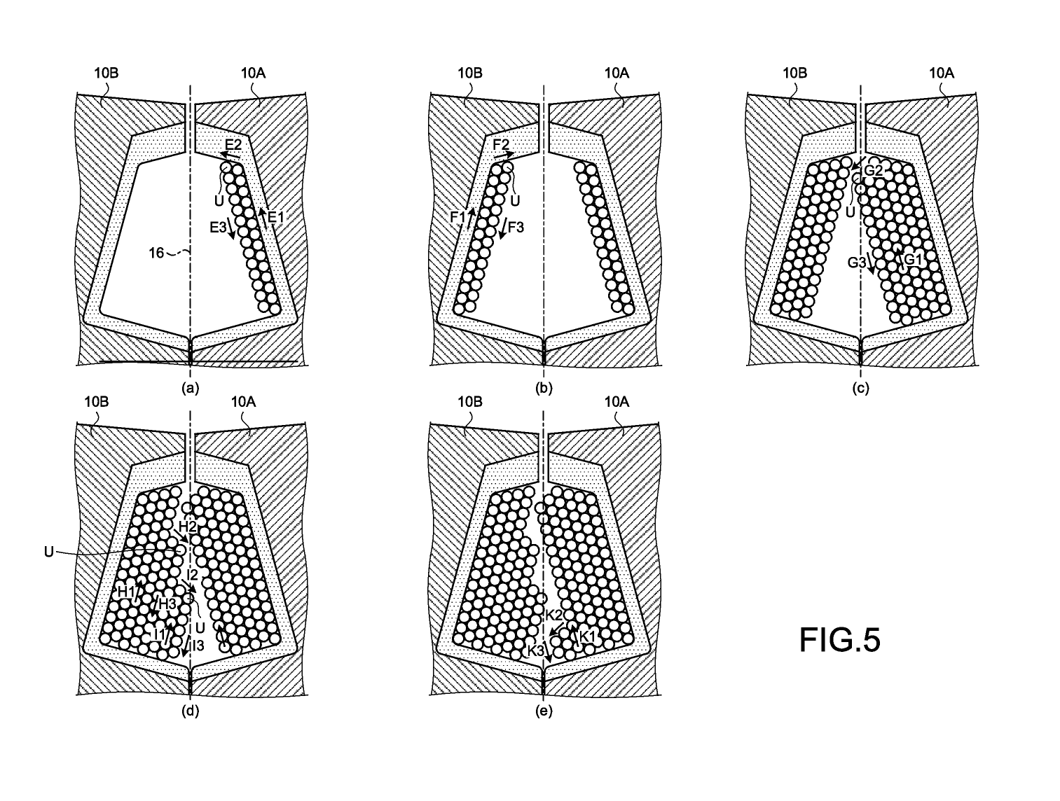

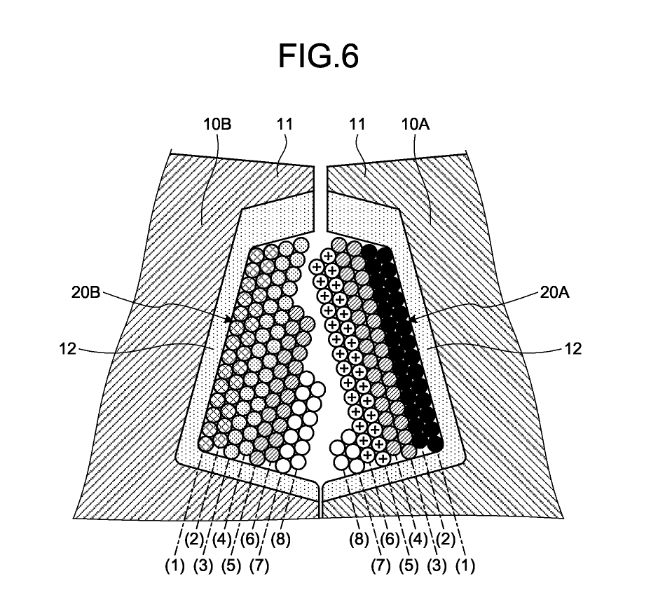

A procedure of the stator 50 according to the present embodiment is explained next with reference to FIGS. 5 and 6. In FIG. 5, a process in which a wire is stacked from the first layer to the last layer is shown step by step. In FIG. 6, the wires to be wound at each step are shown by changing their hatching patterns. The numbers in the parentheses in FIG. 6 represent the array number of the layer.

In the stator 50 configured as described above, the first wire 20A and the second wire 20B are wound around the first teeth 10A and the second teeth 10B. As a premise, a round-trip winding such that an mth m layer is wound in a direction from the base portion (on the side of the core back 13) to the flange portion 11 of the teeth 10, turned around at a predetermined position as a turn-around position, and an m+1 layer is wound back on the m layer is designated as one set.

(1) First, one set of winding is performed around the first teeth 10A in order shown by arrows E1, E2, and E3 as shown in FIG. 5(a). The wire U having reached the flange portion is wound back, designating the position as the turn-around position, so that the first and second layers shown in FIG. 6 are wound.

(2) In the same manner, one set of winding is performed around the second teeth 10B (the first and second layers shown in FIG. 6) in order shown by arrows F1, F2, and F3 as shown in FIG. 5(b).

The above processes (2) and (1) are repeated to wind the wire. That is, when winding of the first layer and the second layer is performed around the respective teeth 10, while transitioning between the respective teeth 10, one set of winding is performed (third and fourth layers) around the respective teeth 10 continuously. In this manner, the wire is wound by one set each step by step in each winding area, while transitioning between the respective teeth from the first teeth 10A. A crossover that electrically connects the first wire 20A and the second wire B is formed by directly pulling out the wire.

(3) As described above, when the wire is wound and stacked to continuously wind five layers of the first wire 20A as shown by an arrow G1 in FIG. 5(c), if the wire in the next sixth layer has reached the boundary surface 16, the wire in the sixth layer is wound back to the base portion as shown by arrows G2 and G3, designating this position as the turn-around position (the position of the wire U). Because which portion of the wire becomes the turn-around position can be determined in the design phase based on the depth of the winding area and the diameter of the wire, the turn-around position is set in the winding machine. In this manner, the fifth and sixth layers shown in FIG. 6 are wound around the first teeth 10A.

At the process (3), the wire U at the turn-around position has reached the boundary surface 16 and at this position, the distance between the wire U and the second wire 20B becomes the minimum insulating distance D. However, the wire is turned around when any one of conditions described above is satisfied.

(4) Next, transition to the second teeth 10B is performed, and one or more sets of winding are performed so that the number of windings becomes substantially the same number of windings t of the fifth and sixth layers of the first wire 20A, taking it into consideration whether the wire has reached the boundary surface 16 or the distance from the first wire 20A becomes the minimum insulating distance. Specifically, as shown in FIG. 5(d), two sets of winding are performed in order shown by arrows H1, H2, H3, I1, I2, and I3. Accordingly, the fifth and sixth layers shown in FIG. 6 are wound around the second wire 20B. The processes (3) and (4) are repeated as required.

(5) Finally, in the first teeth 10A, the wire is wound, while adjusting the number of windings so that the number of windings of the first wire 20A matches with the number of windings of the second wire 20B in the last layer. Specifically, as shown in FIG. 5(e), one set of winding is performed (the seventh and eighth layers shown in FIG. 6) in order as shown by arrow K1, K2, and K3, to finish winding.

As described above, the wire is wound, while adjusting the number of windings so that the number of windings of the first wire 20A matches with the number of windings of the second wire 20B, taking it into consideration whether the wire has reached the boundary surface 16 or the distance between the first wire 20A and the second wire 20B becomes the minimum insulating distance. However, the number of windings of the winding back layer is set to the same number of windings or ±1 of the previous layer.

(Example) “number of windings of first layer”=“number of windings of second winding”

(Example) “number of windings of fifth layer”=“number of windings of sixth layer+one winding”

As described above, according to the stator 50 of the present embodiment, the first wire 20A is wound around the first teeth 10A provided alternately, and the second wire 20B is wound around the second teeth 10B put between the first teeth 10A. The surface that radially divides the space in the slot 15 into two in a tapered shape in cross section is designated as the boundary surface 16, and the closest distance between the first wire 20A and the second wire 20B is designated as the minimum insulating distance D. The wire is wound in the m layer in the direction from a side of the base portion having a wide width toward the flange portion 11 having a narrow width of the teeth in the tapered shape in cross section, turned around at the predetermined position, and wound back in the m+1 layer, stacked on the m layer. This process is designated as one set, and the wire is wound in the winding area by one set each, while transitioning between the respective teeth.

When the boundary surface 16 is exceeded or the distance from the second wire 20B has reached the minimum insulating distance D in an n layer of the first wire 20A, the position is designated as the turn-around position to wind back the wire in an n+1 layer to the base portion. Transition to the second teeth 10B is then performed, and when the boundary surface 16 is exceeded or the distance from the first wire 20A has reached the minimum insulating distance D in the n layer of the second wire 20B, the position is designated as the turn-around position to wind back the wire. This process is repeated by one set or more, transition to the first teeth 10A is performed, and the wire is wound, while adjusting the number of windings so that the number of windings of the first wire 20A matches with the number of windings of the second wire 20B in the last layer.

Therefore, the first wire 20A and the second wire 20B can be wound in a different shape in a sectional shape of the opposing portions so that the convex portion of the first wire 20A corresponds to the concave portion of the second wire 20B, and the concave portion of the first wire 20A corresponds to the convex portion of the second wire 20B, by a simple procedure such that when the boundary surface 16 is exceeded or the minimum insulating distance D is reached, the wire is wound back at this position as the turn-around position. The winding arrangements different in the adjacent teeth 10 can be realized without using any uniquely-shaped insulator or without using any unique winding machine, and improvement of a space factor (a winding density) and downsizing of the device can be realized.

As for how much the wire is wound back, as described in the present embodiment, the wire is ideally wound back to the base portion of the teeth 10 (to the side of the core back 13). However, even if the wire does not reach the base portion completely, by winding back the wire up to the vicinity of the base portion, substantially identical effects can be achieved.

In the present embodiment, the second wire 20B can be wound around the first teeth 10A and the first wire 20A can be wound around the second teeth 10B.

### INDUSTRIAL APPLICABILITY

As described above, the stator of a rotating electric machine and the winding method therefor according to the present invention are suitable for, for example, an AC generator or a starter motor mounted on a vehicle or the like.

### REFERENCE SIGNS LIST

10 teeth
10A first teeth
10B second teeth
11 flange portion
12 insulator
13 core back
15 slot
16 boundary surface
20 wire
20A first wire
20B second wire
D minimum insulating distance

1-7. (canceled)

8. A stator of a rotating electric machine comprising:
a plurality of teeth having a same shape are arranged in a radial direction toward a rotary shaft core with base ends thereof being coupled to a core back in a ring shape; a slot formed between the adjacent teeth;
a flange portion formed projecting to opposite sides of apical ends of the teeth;
a slot inlet formed between the adjacent flange portions;
a winding area formed around each teeth; and
a wire wound via an insulator having a same shape in each winding area, wherein
a first wire is wound around first teeth provided alternately, and a second wire is wound around second teeth put between the first teeth, and
the first wire and the second wire are wound in a different shape in a sectional shape of opposing portions, so that a convex portion of the first wire corresponds to a concave portion of the second wire, a concave portion of the first wire corresponds to a convex portion of the second wire, and a closest distance between the first wire and the second wire becomes a minimum insulating distance.

9. The stator of a rotating electric machine according to claim 8, wherein in the first wire and the second wire, the number of convex portions of the first wire and the number of convex portions of the second wire are different in the sectional shape of the opposing portions.

10. The stator of a rotating electric machine according to claim 8, wherein
a surface that radially divides a space in the slot into two in a tapered shape in cross section is designated as a boundary surface, and
a plurality of convex portions of the first wire and a plurality of convex portions of the second wire are arranged along the boundary surface, and a gap in a direction along the boundary surface is different from each other.

11. The stator of a rotating electric machine according to claim 8, wherein
a surface that radially divides a space in the slot into two in a tapered shape in cross section is designated as a boundary surface,
a closest distance between the first wire and the second wire is designated as the minimum insulating distance,
the wire is wound in the winding area by one set each while transitioning between the respective teeth, the one set being such that the wire is wound in an m layer in a direction from the base portion having a wide width toward the flange portion having a narrow width of the teeth in the tapered shape in cross section, turned around at a predetermined position, and wound back in an m+1 layer, stacked on the m layer, and
when the boundary surface is exceeded by the first wire or the distance from the second wire has reached the minimum insulating distance in an n layer of the first wire, the position is designated as a turn-around position to wind back the wire in an n+1 layer.

12. The stator of a rotating electric machine according to claim 11, wherein
when the boundary surface is exceeded by the first wire or the distance from the second wire has reached the minimum insulating distance in an n layer of the first wire, the position is designated as a turn-around position to wind back the wire in an n+1 layer to the base portion,
transition to the second teeth is performed, and when the boundary surface is exceeded by the second wire or the distance from the first wire has reached the minimum insulating distance in an n layer of the second wire, the position is designated as a turn-around position to wind back the wire, which is designated as one set, and this process is repeated by one set or more, and
transition to the first teeth is performed, and the wire is wound while adjusting number of windings so that number of windings of the first wire matches with number of windings of the second wire in the last layer.

13. The stator of a rotating electric machine according to claim 8, wherein entirety of the wires turned around at the turn-around position are wound back to the base portion of the teeth.

14. The stator of a rotating electric machine according to claim 8, wherein the wire is directly used as a crossover that electrically connects the first wire and the second wire.

15. A stator of a rotating electric machine comprising:
a plurality of teeth having a same shape are arranged in a radial direction toward a rotary shaft core with base ends thereof being coupled to a core back in a ring shape; a slot formed between the adjacent teeth;
a flange portion formed projecting to opposite sides of apical ends of the teeth;
a slot inlet formed between the adjacent flange portions;
a winding area formed around each teeth;
a wire wound via an insulator having a same shape in each winding area;
a first wire wound around first teeth provided alternately, and a second wire is wound around second teeth put between the first teeth; and
a surface that radially divides a space in the slot into two in a tapered shape in cross section is designated as a boundary surface, wherein
a closest distance between the first wire and the second wire is designated as a minimum insulating distance,
the wire is wound in the winding area by one set each while transitioning between the respective teeth, the one set being such that the wire is wound in an m layer in a direction from the base portion having a wide width toward the flange portion having a narrow width of the teeth in the tapered shape in cross section, turned around at a predetermined position, and wound back in an m+1 layer, stacked on the m layer,
when the boundary surface is exceeded by the first wire or the distance between the first wire and the second wire has reached the minimum insulating distance in an n layer of the first wire, the position is designated as a turn-around position to wind back the wire in an n+1 layer,
transition to the second teeth is performed, and when the boundary surface is exceeded by the second wire or the distance between the second wire and the first wire has reached the minimum insulating distance in an n layer of the second wire, the position is designated as a turn-around position to wind back the wire, which is designated as one set, and this process is repeated by one set or more, and
transition to the first teeth is performed, and the wire is wound while adjusting number of windings so that number of windings of the first wire matches with number of windings of the second wire in the last layer.

16. The stator of a rotating electric machine according to claim 15, wherein entirety of the wires turned around at the turn-around position are wound back to the base portion of the teeth.

17. The stator of a rotating electric machine according to claim 15, wherein the wire is directly used as a crossover that electrically connects the first wire and the second wire.

18. A winding method for a stator of a rotating electric machine, the stator comprising:
a plurality of teeth having a same shape are arranged in a radial direction toward a rotary shaft core with base ends thereof being coupled to a core back in a ring shape; a slot formed between the adjacent teeth;
a flange portion formed projecting to opposite sides of apical ends of the teeth;
a slot inlet formed between the adjacent flange portions; and
a winding area formed around each teeth, and a wire is wound via an insulator having a same shape in each winding area, the winding method comprising:
winding a first wire around first teeth provided alternately, and winding a second wire around second teeth put between the first teeth;
designating a surface that radially divides a space in the slot into two in a tapered shape in cross section as a boundary surface;
designating a closest distance between the first wire and the second wire as a minimum insulating distance;
winding the wire in the winding area by one set each while transitioning between the respective teeth, the one set being such that the wire is wound in an m layer in a direction from the base portion having a wide width toward the flange portion having a narrow width of the teeth in the tapered shape in cross section, turned around at a predetermined position, and wound back in an m+1 layer, stacked on the m layer;
winding the wire in an n+1 layer to the base portion, when the boundary surface is exceeded by the first wire or the distance from the second wire has reached the minimum insulating distance in an n layer of the first wire, by designating the position as a turn-around position;
transitioning to the second teeth, and when the boundary surface is exceeded by the second wire or the distance from the first wire has reached the minimum insulating distance in an n layer of the second wire, winding back the wire by designating the position as a turn-around position, this process being repeated by one set or more; and
transitioning to the first teeth, and the wire is wound while adjusting number of windings so that number of windings of the first wire matches with number of windings of the second wire in the last layer.
